(19) United States
(12) Patent Application Publication
(10) Pub. No.: US 2013/0171945 A1
(43) Pub. Date: Jul. 4, 2013

(54) METHOD FOR TESTING RADIO FREQUENCY INTERFERENCE OF ELECTROMAGNETIC COMPATIBILITY CHAMBER

(71) Applicant: YONG-SHENG YANG, Shenzhen City (CN)

(72) Inventor: YONG-SHENG YANG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/420,554

(22) Filed: Mar. 14, 2012

(30) Foreign Application Priority Data
Dec. 30, 2011 (CN) 201110452531.0

(51) Int. Cl. H04B 17/00

(52) U.S. Cl. 455/67.13

(57) ABSTRACT

A method for testing radio frequency interference (RFI) of electromagnetic compatibility (EMC) chamber includes: setting a threshold value of noise bandwidth (NBW) on the computer in response to user's operation, activating a signal source in the EMC chamber to transmit test signals using the computer, adjusting the antenna to a predetermined height and orients a polarization direction along a vertical direction, and controlling the signal source to rotate using the computer, testing the EMC chamber to obtain a NBW value, and comparing the NBW value with the threshold value to determine the RFI of the EMC chamber.

### BACKGROUND

1. Technical Field

The present disclosure relates to electromagnetic compatibility (EMC) testing technology, and particularly to a method for testing radio frequency interference (RFI) of the EMI chamber.

2. Description of the Related Art

EMC chamber configured for testing EMC of electronic devices usually employs two antennas. Generally, when testing EMC in the EMC chamber, parameters of each of the two antennas should be respectively tested in vertical polarization direction and horizontal polarization direction using a signal source. Thereby, each antenna needs be tested twice, lowering tests efficiency.

Therefore, there is room for improvement within the art.

### BRIEF DESCRIPTION OF THE DRAWINGS

The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of a testing system applied in an electromagnetic compatibility chamber in accordance with an exemplary embodiment.

FIG. 2 is a flowchart illustrating a method for testing radio frequency interference of the electromagnetic compatibility chamber of FIG. 1, in accordance with an exemplary embodiment.

### DETAILED DESCRIPTION

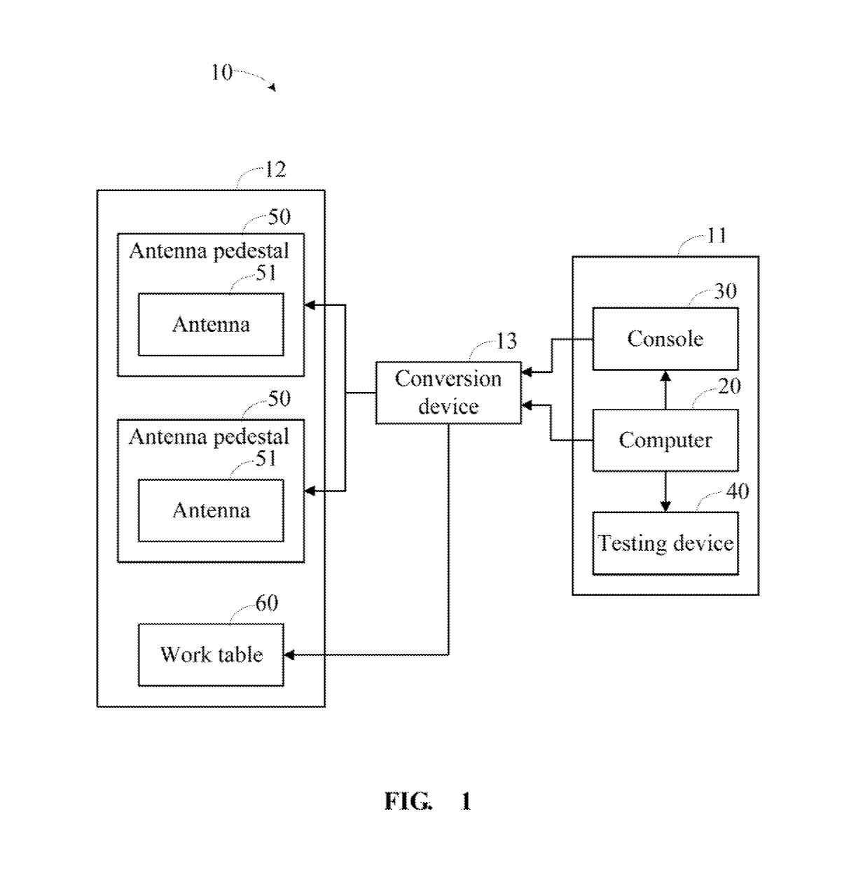

FIG. 1 is a block diagram of a testing system 10 applied in an EMC chamber. The system 10 includes an operating room 11 and an EMC chamber 12. The operating room 11 includes a computer 20, a console 30, and a testing device 40. The EMC chamber 12 includes a work table 60 and an antenna pedestal 50 configured for mounting an antenna 51. The computer 20, the console 30, and the testing device 40 are communicating with the antenna pedestal 50 and the work table 60 via a conversion device 13. The computer 20 controls height and polarization direction of the antenna pedestal 50 and rotation angle of the work table 60 by running a testing software.

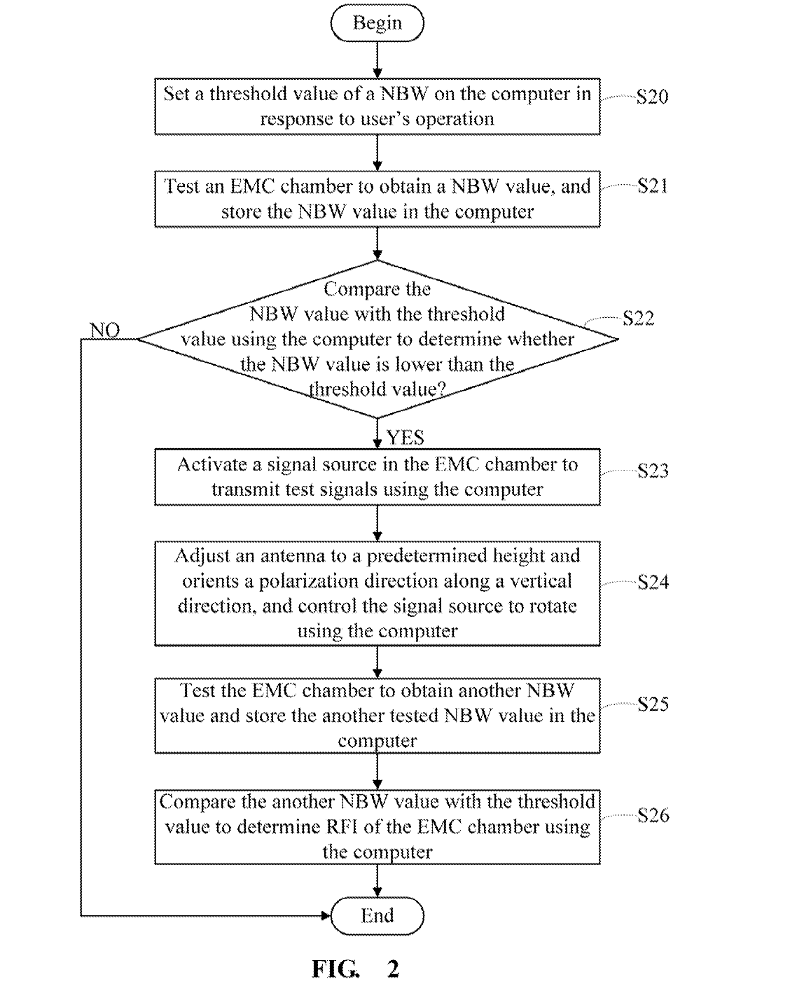

FIG. 2 is a flowchart of a method for testing RFI of the EMC chamber of FIG.1, in accordance with an exemplary embodiment.

In step S20, the computer 20 provides a user interface for operator to set a threshold value of a noise bandwidth (NBW). In the embodiment, the threshold value of NBW is about 6 dB.

In step S21, the computer 20 runs an EMI testing software to test the NBW value of the EMC chamber 12, and stores the tested NBW value.

In step S22, the computer 20 compares the tested NBW value with the threshold value. If the tested NBW value is larger than the threshold value, the procedure ends, if the tested NBW value is less than the threshold value, the procedure goes to step S23.

In step S23, the computer 20 activates the signal source put on the work table 60 in the EMC chamber 11.

In step S24, the computer 20 generates a control signal to the console 30 to adjust the antenna 51 mounted on the antenna pedestal 50 to a predetermined height, orients a polarization direction of the antenna 51 along a vertical direction, and further controls the work table 60 to rotate to make the signal source to rotate a circle (360 degrees) during the signal source transmitting test signals.

In the embodiment, the EMC chamber 11 includes two antenna pedestals 50 to mount two antennas 51. The predetermined height value is 4 meter. In an alternative embodiment, the EMC chamber 11 includes one antenna pedestal 50 to mount one antenna 51.

In step S25, the computer 20 tests the NBW value of the EMC chamber 11 with the activated signal source by running the EMI testing software, and stores the tested NBW value therein.

In step S26, the computer 20 compares the tested NBW value with the threshold value. If the tested NBW value is larger than the threshold value, the EMC chamber 11 is determined to be in abnormal, namely, the NBW value of the EMC chamber 11 is too larger to be used to test electronic device. If the tested NBW value is less than the threshold value, the EMC chamber 11 is determined to be in a normal, namely the EMC chamber 11 can be used to test electronic device therein.

It is understood that the present disclosure may be embodied in other forms without departing from the spirit thereof. Thus, the present examples and embodiments are to be considered in all respects as illustrative and not restrictive, and the disclosure is not to be limited to the details given herein.

What is claimed is:

1. A method for testing radio frequency interference (RFI) of an electromagnetic compatibility (EMC) chamber, wherein the EMC chamber comprises at least one antenna for communicating with a computer in an operating room, the method comprising:
(1) setting a threshold value of noise bandwidth (NBW) on the computer in response to user's operation;
(2) activating a signal source in the EMC chamber to transmit test signals using the computer;
(3) adjusting the at least one antenna to a predetermined height, and orienting a polarization direction of the at least one antenna along a vertical direction, and controlling the signal source to rotate using the computer;
(4) testing the EMC chamber to obtain a first NBW value thereof and storing the first NBW value in the computer; and
(5) comparing the first NBW value with the threshold value to determine the RFI of the EMC chamber using the computer.

2. The method as recited in claim 1, wherein when the first NBW value is lower than the threshold value, the EMC chamber is determined by the computer to be in a normal and qualified state for testing an electronic device therein.

3. The method as recited in claim 1, further comprising prior to the procedure (2), testing the EMC chamber to obtain a second NBW value thereof, and storing the second NBW value in the computer; and
comparing the second NBW value with the threshold value using the computer, wherein when the second NBW value is larger than the threshold value, the procedure ends, when the second NBW value is lower than the threshold value, the procedure goes to the procedure (2).

4. The method as recited in claim 1, wherein the threshold value of NBW is 6 dB.

5. The method as recited in claim 1, wherein the predetermined height value is 4 meters. the signal source is controlled to rotate 360 degrees.

6. The method as recited in claim 1, wherein the number of the at least one antenna is two.

7. The method as recited in claim 1, wherein the number of the at least one antenna is one.

8. The method as recited in claim 1, wherein the EMC chamber further comprises a work table configured for support the signal source, the computer controls the signal source to rotate by moving the work table.
